(19) United States
(12) Patent Application Publication
(10) Pub. No.: US 2020/0393806 A1
(43) Pub. Date: Dec. 17, 2020

(54) Automatic Monitoring of Process Controls

(71) Applicant: PHOENIX CONTACT GmbH & Co. KG, Blomberg (DE)

(72) Inventors: Benno Heines, Detmold (DE); Peter Biermann, Bielefeld (DE); Michael Weking, Paderborn (DE)

(21) Appl. No.: 16/904,306

(22) Filed: Jun. 17, 2020

(30) Foreign Application Priority Data
Jun. 17, 2019 (LU) LU101274

(51) Int. Cl. G05B 19/042; G06F 11/30; G06F 11/34

(52) U.S. Cl. CPC G05B 19/0426; G05B 2219/13004; G06F 11/3495; G06F 11/302

(57) ABSTRACT

The present invention relates to a system (100) for monitoring process controls, said system (100) comprising: an engineering tool module (10) configured to provide process control for an engineering product and to accomplish initializing of the process control of the engineering product; and a monitoring tool module 20) configured to be co-executed with the initializing of the process control of the engineering product and to be coupled to the process control of the engineering product.

### TECHNICAL FIELD

The present invention relates to systems for the automatic monitoring of process controls.

In particular, the present invention relates to a device and method for the automatic monitoring of process controls.

### TECHNICAL BACKGROUND

In order to be able to test or observe automation programs in operation, also known as “monitoring”, the sources of the running control program are nowadays stored either on the controller or a PC.

In order to be able to read or change the values of the running control, an installed engineering product is required, such as PLCnext Engineer, an engineering software platform for automation controls.

It should be noted that the version of the engineering product installed at the user's site must be compatible with the version of the running project on the controller.

This leads either to high efforts on the part of the product manufacturer to keep newer product versions compatible with old project statuses, or on the part of the user, who has to keep old product versions that match the projects on the controller as an installation. In addition, depending on the application, it should only be possible to read values or overwrite values, but not to modify the programs. Neither of these is possible with a product installed on the user's computer.

### SUMMARY OF THE INVENTION

It is an object of the present invention to provide an improved system and an improved method for automatically monitoring the process control of a control device.

This task is solved by the subject-matter of the independent patent claims. Further details and embodiments are provided by the dependent patent claims, the description and the figures of the drawings.

A first aspect of the present invention relates to a system for monitoring process controls, said system comprising: an engineering tool module configured to provide process control for an engineering product and to accomplish initializing of the process control of the engineering product; and a monitoring tool module configured to be co-executed with the initializing of the process control of the engineering product and to be coupled to the process control of the engineering product.

The present invention advantageously enables to create a monitoring tool, the monitoring tool module, which enables to test or observe a project running on the controller with a computer without having to keep a pre-installed engineering product which is compatible with the version of the project.

The tool should connect directly to the project running on the controller and should specifically provide only the functions required for maintenance (only reading or overwriting values, setting breakpoints, stopping and restarting the controller).

The level of intervention in the course of the process control should also be defined by the monitoring tool. Any further manipulation, such as changing the program logic, loading new projects or accessing further data of the controller should be prevented.

Contrary to the state of the art, a self-contained package on the controller provides the application with its completely required environment in order to test the running program on a computer with an operating system without having to install the product on this computer.

Advantageous embodiments of the present invention are provided by the dependent claims and the description.

In an advantageous embodiment of the present invention, it is provided that the monitoring tool module is configured to test and/or observe the process control of the engineering product.

In an advantageous embodiment of the present invention it is provided that the module is configured to be executed according to an installation matrix on a programmable logic controller and/or on a general-purpose computer, i.e. a PC.

In an advantageous embodiment of the present invention, it is provided that the monitoring tool module is configured to be co-installed with an installation of the engineering tool module.

In an advantageous embodiment of the present invention it is provided that the monitoring tool module is adapted to be started and/or operated by a maintenance system coupled to the device.

In an advantageous embodiment of the present invention, it is provided that the monitoring tool module is configured to carry out a plurality of permitted accesses to the process control of the engineering product.

In an advantageous embodiment of the present invention, it is provided that the monitoring tool module is configured to be implemented in a project code of the process control of the engineering product.

In an advantageous embodiment of the present invention it is provided that the monitoring tool module is configured to carry out a check of operating parameters and values of the process control of the engineering product.

In an advantageous embodiment of the present invention it is provided that the monitoring tool module is configured to carry out a change of operating parameters and values of the process control of the engineering product.

In an advantageous embodiment of the present invention it is provided that the monitoring tool module is configured carry out a change and/or a setting of breakpoints of the process control of the engineering product, particularly preferably to carry out a stopping and/or a restarting of the process control of the engineering product.

According to a second aspect of the present invention, a method for monitoring process controls is provided, wherein the method comprises the following method steps:

As a first method step, providing a process control for an engineering product by means of an engineering tool module is performed.

As a second method step, accomplishing an initializing of the process control by means of the engineering tool module is performed.

As a third process step co-executing a monitoring tool module with the initializing of the process control of the engineering product is performed.

As a fourth process step, coupling the monitoring tool module with the engineering tool module is conducted.

According to a third aspect, the present invention comprises a computer program or a computer program product comprising instructions which, when executed by a computer, cause the computer to execute the steps of the method according to the second aspect or any execution form of the second aspect.

According to a fourth aspect, the present invention comprises a computer-readable storage medium comprising instructions which, when executed by a computer, cause the computer to carry out the steps of the method according to the second aspect or any execution form of the second aspect.

The described embodiments and examples of the aspects of the present invention can be combined with each other as desired.

Further possible embodiments and examples and implementations of the present invention also include combinations of features of the present invention not explicitly mentioned before or in the following described with regard to the embodiments.

The enclosed drawings should give a further understanding of the aspects and the embodiments of the present invention.

The attached drawings illustrate embodiments and are used in connection with the description of the explanation of concepts of the present invention.

Other embodiments and many of the advantages mentioned above arise in relation to the figures in the drawings. The depicted elements of the figures of the drawings are not necessarily true to scale.

### BRIEF DESCRIPTION OF THE DRAWINGS

FIG. 1: shows a schematic representation of a matrix for use on the controller and/or on a PC according to an exemplary embodiment of the present invention; and

FIG. 2: shows a schematic representation of a flow chart of a start-up routine or a method according to an exemplary embodiment of the present invention;

FIG. 3: shows a schematic representation of a flowchart of a routine from tool creation to deployment according to an exemplary embodiment of the present invention;

FIG. 4: shows a schematic representation of the process from the creation of the project to the application of the monitoring tool according to an exemplary embodiment of the present invention;

FIG. 5: shows a schematic representation of a system for monitoring process controls according to an exemplary embodiment of the present invention;

FIG. 6: shows a schematic representation of a flow chart of a method for monitoring process controls according to an exemplary embodiment of the present invention.

### DETAILED DESCRIPTION OF THE EMBODIMENT

Unless otherwise indicated, identical reference signs in the figures of the drawings indicate identical or functionally identical elements, parts, components or process steps.

According to an exemplary embodiment of the present invention, a virtualized monitoring tool or a monitoring tool module is used, which is stored directly with the project and its sources on the controller or a PC.

In addition to the tool or module itself, the virtualization of the tool application contains a package with all necessary runtime routines, configurations and system components required for execution.

The term “engineering tool”, as for example used in the description of the present invention in the term “engineering tool module” or also used elsewhere, describes a tool for the creation of a control unit. In other words, an “engineering tool” describes a “production and configuration tool” for projecting and/or configuring a control unit.

The term “monitoring tool”, as for example used in the description of the present invention in the term “monitoring tool module” or also used elsewhere, describes a tool for monitoring a control unit. In other words, a “monitoring tool” describes a system for monitoring and checking the operation of a control unit, whereby active intervention can also take place.

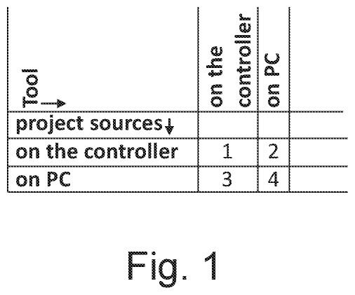

FIG. 1 shows a schematic diagram of a matrix for use on the control unit and/or PC. For example, four combinations are possible, as shown in FIG. 1.

In addition, the monitoring tool module is installed with the help of the engineering product module. The monitoring tool module can then be stored in the environment of the plant operator or manufacturer during commissioning or initializing of the control system by the engineering product according to the above table with the project sources for the purpose of later testing or observation on the control system or a PC according to the combinatorics of the above-mentioned matrix shown in FIG. 1.

Uploading the sources and the required monitoring tool module is offered as an option in the engineering product directly during the creation and transfer of the project code to the controller.

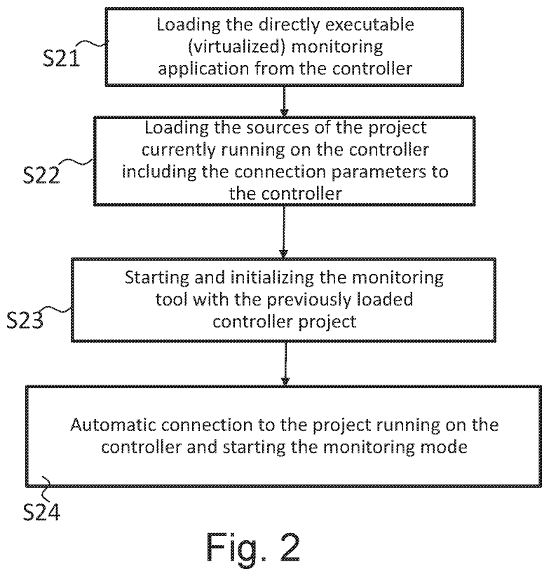

FIG. 2 shows a schematic representation of the start-up routine according to an exemplary embodiment of the present invention.

In a first process step S21, the directly executable (virtualized) monitoring application is loaded from the controller.

In a second process step S22 the source code or the source code of a computer program of the project currently running on the controller is loaded, for example including the connection parameters to the controller.

In a third process step S23 the monitoring tool is started and initialized with the previously loaded control project.

In a fourth process step S24 an automatic connection with the project currently running on the controller is made and the monitoring mode is started.

According to an exemplary embodiment of the present invention, this tool can be transferred directly from the controller and/or a PC to a connected maintenance computer and executed without installation.

According to an exemplary embodiment of the present invention, an included start-up routine as shown in FIG. 2 ensures that the transferred tool automatically loads the source project from the control to a PC upon start-up and connects to the project running on the control for testing or monitoring.

Here it can be ensured that only permitted accesses (such as display of the values, overwriting of the values, setting of breakpoints, stopping and restarting of the controller) are possible in the provided tool.

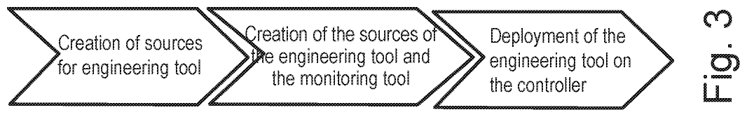

FIG. 3 shows a schematic representation of a process from tool creation to deployment according to exemplary embodiment of the present invention.

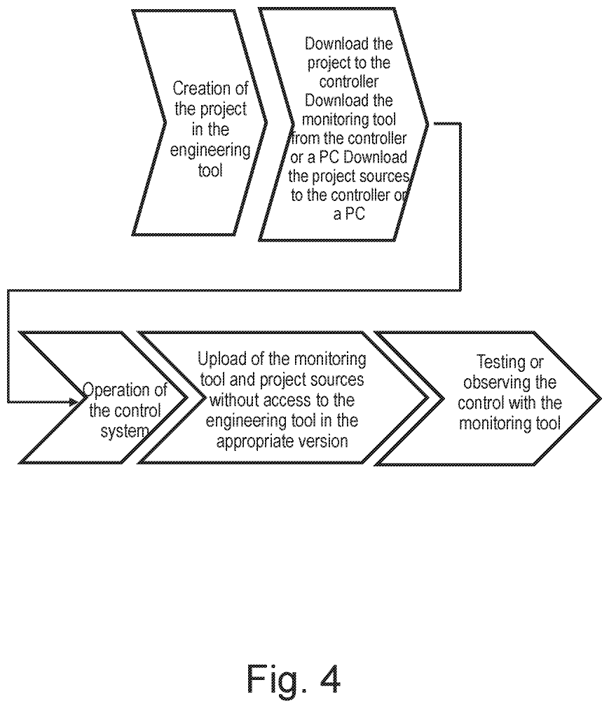

FIG. 4 shows a schematic representation of the process from the project creation to the application of the monitoring tool according to an exemplary embodiment of the present invention.

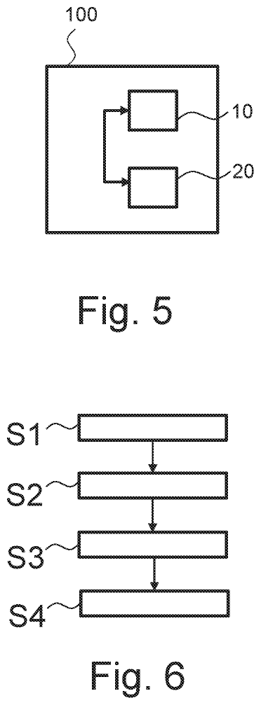

FIG. 5 shows a schematic representation of a system for monitoring process controls according to an exemplary embodiment of the present invention.

The system 100 for monitoring process controls comprises an engineering tool module 10 and a monitoring tool module 20.

The engineering tool module 10 is configured to provide process control for an engineering product and to perform commissioning or initializing of the process control of the engineering product.

The monitoring tool module 20 is configured to be executed during the commissioning of the process control of the engineering product and to be coupled with the process control of the engineering product.

The engineering tool or the engineering tool module 10, as used as a term by the present invention, can therefore, according to an exemplary embodiment of the present invention, for example, provide an aid for programming in graphical and textual form according to IEC-61131.

Likewise, the engineering tool or the engineering tool module 10, as used as an execution example of the present invention, may be configured or adapted to perform a configuration of fieldbus/Ethernet components and network system.

The monitoring tool module 20 is, for example, according to an exemplary embodiment of the present invention, configured to monitor the function of the components and systems during operation of the fieldbus/Ethernet components and network systems.

Likewise, the engineering tool or the engineering tool module 10 can be configured, according to an exemplary embodiment of the present invention, to provide a connection configuration of process data with program input and output parameters or to create test and operating visualizations for control and/or production systems.

According to an exemplary embodiment of the present invention, the monitoring tool module 20 is configured, for example, according to an exemplary embodiment of the present invention, to monitor the control and/or production systems and to monitor a running process control, for example by means of monitoring the process data and/or the associated program-specific input and output parameters.

Likewise, the engineering tool or the engineering tool module 10 according to an exemplary embodiment of the present invention can be configured to accomplish a programming and/or a configuration of safety-relevant controls according to IEC-61508. The monitoring tool module 20, for example, is configured according to an exemplary embodiment of the present invention to monitor the safety-relevant controls according to IEC-61508.

Furthermore, the monitoring tool module 20 can be used for automated diagnosis of running programs by setting breakpoints or for observation and/or overwriting of values.

The engineering tool or the engineering tool module 10 can therefore also be configured, for example, as an aid for compiling the programs and transferring the programs and configurations to a process controller. This can be done, for example, in the area of building services and building automation, so the engineering tool module 10 can initialize and configure heating, lamp, shutter and garage door control.

The engineering tool module 10 can therefore also be used as an aid in the field of industrial production, for example, and can enable the creation, configuration and maintenance of automated controls in entire production lines.

The engineering tool module 10 can also be used in the area of the creation and configuration of photovoltaic and wind power plants, process engineering plants, power stations, automated control and regulation systems in the area of railways, shipping or air transport or also traffic control systems such as traffic lights.

FIG. 6 shows a schematic representation of a flow chart of a process for monitoring process controls according to an exemplary embodiment of the present invention.

FIG. 6 shows a method for monitoring process controls provided, the method comprising the following process steps:

As a first method step, providing S1 a process control for an engineering product by means of an engineering tool module 10 is performed.

As a second method step, accomplishing S2 an initializing of the process control by means of the engineering tool module 10 is performed.

As a third process step co-executing S3 a monitoring tool module 20 with the initializing of the process control of the engineering product is performed.

As a fourth process step, coupling S4 the monitoring tool module 20 with the engineering tool module 10 is conducted.

Although the present invention has been described above on the basis of preferred exemplary embodiments or examples, it is not limited to this, but can be modified in many ways.

In particular, the invention can be changed or modified in a variety of ways without deviating from the core of the invention.

In addition, it should be noted that “comprising” and “having” does not exclude other elements or steps, and “one” or “one” does not exclude a plurality.

It should further be noted that features or steps described by reference to one of the above examples of execution may also be used in combination with other features or steps of other examples of execution described above. Reference marks in the claims should not be considered as a restriction.

1. A system for monitoring process controls, said system comprising:
an engineering tool module configured to provide process control for an engineering product and to accomplish initializing of the process control of the engineering product; and
a monitoring tool module configured to be co-executed with the initializing of the process control of the engineering product and to be coupled to the process control of the engineering product.

2. The system according to claim 1, wherein the monitoring tool module is adapted to test or observe the process control of the engineering product.

3. The system according to claim 1, wherein the device is adapted to be executed according to an installation matrix on at least one of a programmable logic controller or a general purpose computer.

4. The system according to claim 1, wherein the monitoring tool module is adapted to be installed at the same time as the engineering tool module is installed.

5. The system according to claim 1, wherein the monitoring tool device is adapted to at least one of be started or operated by a maintenance system coupled to the device.

6. The system according to claim 1, wherein the monitoring tool module is adapted to perform a plurality of permitted accesses to the process control of the engineering product.

7. The system according to claim 1, wherein the monitoring tool module is adapted to be implemented in a project code of the process control of the engineering product.

8. The system according to claim 1, wherein the monitoring tool module is adapted to perform a check of operating parameters and values of the process control of the engineering product.

9. The system according to claim 1, wherein the monitoring tool module is adapted to perform a change of operating parameters and values of the process control of the engineering product.

10. The system according to claim 1, wherein the monitoring tool device configured to at least one of carry out a change or stopping points of the process control of the engineering product to carry out at least one of a stopping or a restarting of the process control of the engineering product.

11. A method for monitoring process controls, the method comprising the following process steps:
providing a process control for an engineering product using an engineering tool module;
accomplishing initializing of the process control using the engineering tool module;
co-executing a monitoring tool module with the initializing of the process control of the engineering product; and
coupling the monitoring tool module with the engineering tool module.

12. The method according to claim 11, the method further comprising at least one of testing or observing the process control of the engineering product using the monitoring tool module.
